(19) United States
(12) Patent Application Publication
(10) Pub. No.: US 2025/0364726 A1
(43) Pub. Date: Nov. 27, 2025

(54) METASURFACE BASED BROADBAND RADAR ABSORBERS FOR STEALTH APPLICATIONS

(71) Applicants: Muhammad Umar Draz, Sahiwal (PK); Muhammad Abuzar Baqir, Sahiwal (PK); Sami Ullah, Abha (SA); Majid Niaz Akhtar, Bahawalpur (PK); Mohammed Mujahid Alam, Abha (SA); Abdullah G. Al-Sehemi, Abha (SA); Rana Arslan Ali Khan, Riyadh (SA); Mohammed Ali Assiri, Abha (SA)

(72) Inventors: Muhammad Umar Draz, Sahiwal (PK); Muhammad Abuzar Baqir, Sahiwal (PK); Sami Ullah, Abha (SA); Majid Niaz Akhtar, Bahawalpur (PK); Mohammed Mujahid Alam, Abha (SA); Abdullah G. Al-Sehemi, Abha (SA); Rana Arslan Ali Khan, Riyadh (SA); Mohammed Ali Assiri, Abha (SA)

(73) Assignee: Central Lab, King Khalid University, Abha (SA)

(21) Appl. No.: 19/253,725

(22) Filed: Jun. 28, 2025

(51) Int. Cl. H01Q 17/00

(52) U.S. Cl. CPC H01Q 17/008

(57) ABSTRACT

The present invention discloses a metasurface-based broadband radar absorber for stealth applications based on (FR-4) dielectric substrate. A gap resistance between the metasurface patches is used to control the absorption by changing the resistance of chip resistors. The bandwidth of the absorber is 12 GHz from 6 GHz to 18 GHz with more than 80% absorptivity. The present absorber is polarization-insensitive and shows large angular stability from 0° to 55°. The metasurface-based broadband radar absorber (MBRA) structure according to the present invention is simple in structure and easy to process, with a thickness less than one-sixth of the working wavelength, and greatly reduces size and costs.

### TECHNICAL FIELD

The present invention belongs to the technical field of radar absorbers and particularly relates to an absorbent body for high-frequency electromagnetic waves based on metamaterial.

### BACKGROUND

Artificial materials—metamaterials have attracted significant interest because these exhibit fantastic electromagnetic properties which are unusual or difficult to obtain in the natural media. With the rapid development, metamaterial with dynamical mass anisotropy has been applied to develop acoustic cloaks, hyper lenses, perfect absorbers, gradient index lenses, meta lenses, optofluidic barrier, polarization convertor, etc.

There are two types of perfect EM wave absorbers: (i) resonant absorbers and (ii) broadband absorbers. The broadband absorbers are further divided into two categories. The first one is a geometric transition absorber, which consists of two-dimensional periodic arrays of lossy foam pyramids, cones or wedges, is widely used in anechoic rooms to reduce wall reflections. The second one is a low-density absorber. It utilizes very porous or sparse material.

These classifications were done before MMs were introduced in the research field of PA. So far, the resonant absorbers can have perfect absorption in a narrow bandwidth, while only non-resonant techniques were known to be employed for broadband absorption. In the progress of research on MMs, however, the resonant absorbers can have broadband behavior. In this review, we will not discuss geometric-transition and low-density absorbers, and only focus on the resonant EM-wave absorbers, based on MMs, which can possess broadband behaviors and other useful properties for real applications.

### SUMMARY

In the view of above-mentioned problems, the present invention provides broadband radar absorber, which can be used to absorb incident electromagnetic waves.

The given invention consists of three layers: (i) a layer of periodically arranged metallic patterns, (ii) a dielectric layer, and (iii) a continuous metallic layer. It is nearly the same as the case of Salisbury screen; however, there are two differences. The first layer of glossy screen is replaced by a layer of periodically arranged metallic patterns, and the thickness of the dielectric layer could be much smaller than the wavelength, especially, in the GHz regime. To accomplish the total absorption, there should be no reflection and no transmission. No transmission can be accomplished by the third layer of a continuous metallic plate, which completely blocks all incident EM waves. Since the third metallic layer simply reflects all EM wave falling upon it, not much talk about it is needed.

In order to implement the objective of the present invention, the technical solution adopted by the present invention is as follows: a meta-material based broad-band radar absorber (MMRA), which is composed of symmetrical MMRA units arranged in a two-dimensional periodic manner; the MMRA unit includes an upper metal patch, a middle dielectric substrate, a lower metal ground and a resistor group; the upper metal patch is composed of a central spherical metal patch, a hollow spherical ring with 8 resistors, a group of 8 conical metal patches inside the hollow ring with 8 resistors and a group of 8 metal patches outside the hollow ring connected by 8 resistors and printed on the dielectric substrate, and a bottom surface of the upper metal patch is provided with the metal ground; the metal patches outside and inside the hollow ring are connected with each other through resistors.

The total thickness of metal ground and MMRA unit is represented by ‘t1’ and the total thickness of dielectric substrate is represented by ‘t2’. The length of the substrate and the metal ground is represented by ‘a’; the radius of central spherical metal patch is denoted by ‘r0’; the inner radius of hollow spherical ring is represented by ‘r1’; the outer radius of hollow spherical ring is represented by ‘r2’; radius of the complete MMRA unit is ‘r’; width of the strip's b/w patches is represented by ‘c’ and resistors are denoted by ‘R1’, ‘R2’ so on up till ‘R24’.

### BRIEF DESCRIPTION OF THE DRAWINGS

FIG. 1 is a schematic view of a periodic structure of an MMRA unit according to the present invention.

FIG. 2 is a three-dimensional schematic view of an MMRA unit.

FIG. 3 is a side view of the MMRA unit.

FIG. 4 is a perspective view of the MMRA unit.

FIG. 5 is a table of parameters values of MMRA unit.

FIG. 6 is a curve graph of a reflection value of the MMRA unit in required frequency band.

FIG. 7 is a curve graph of an absorption value of the MMRA unit in TE polarization.

FIG. 8 is a curve graph of an absorption value of the MMRA unit in TM polarization.

### DETAILED DESCRIPTION

The following further describes the present invention in detail with reference to the accompanying drawings and examples.

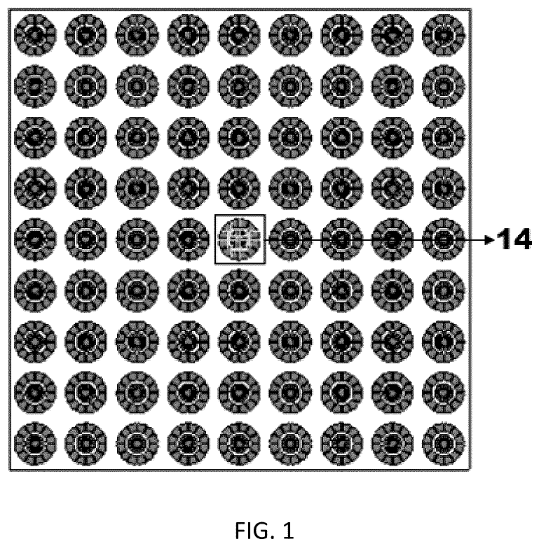

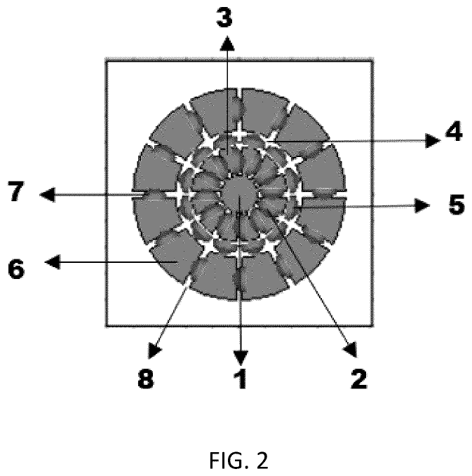

As shown in FIG. 1, a metamaterial based broad-band radar absorber according to the present invention is composed of plurality of centrally symmetrical MMRA units 14 arranged in a two-dimensional periodic manner in the form of a square lattice. As shown in FIG. 2, the MMRA unit 14 consists of an upper meta-surface patch, a middle dielectric substrate, a lower metal ground and a resistor group.

The upper meta-surface patch is composed of a central circular meta-surface patch 1, a group of hollow strips 8, a hollow circular ring 4, a group of meta-surface patches below the circular ring 3, a group of meta-surface patches above the circular ring 6 and printed on dielectric substrate 10. Bottom of the substrate is provided with the metal ground 9. Above the meta-surface patch there is an air gap 11, which is followed by a meta-dome 12.

The meta-surface patches below the hollow circular ring are connected through a group of 8 resistors 2, the meta-surface patches above the hollow circular ring are connected through a group of 8 resistors 7 and the meta-surface patches above and below the hollow circular ring are connected through a group of 8 resistors 4.

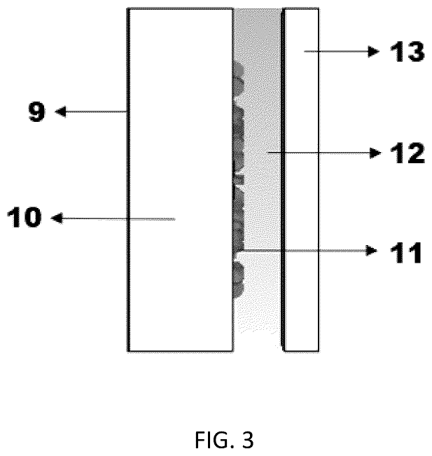

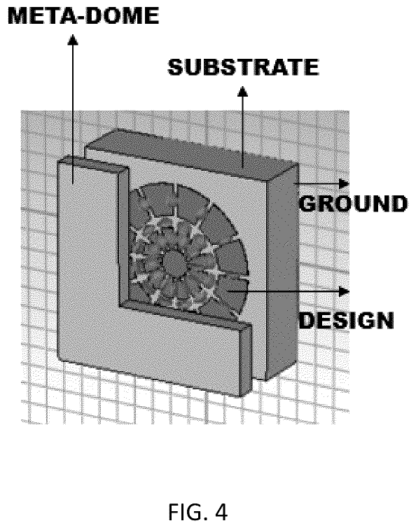

As shown in FIG. 3, the side view of MMRA unit discloses a metal ground at the bottom 9, a dielectric substrate above the metallic ground 10, a meta-surface patch 11, an air gap above the meta-surface patch 12 and a meta-dome at the top 13. As shown in FIG. 4, the perspective view of MMRA units depicted the cutting view of MMRA unit.

As shown in FIG. 2, the perimeter of the square meta-surface patch λₒₚ/2, wherein λₒₚ=λ₀/(εᵣ+1)^{0.5}, and λ₀ is a wavelength of a free space. The dielectric substrate 10 has a dielectric constant εᵣ of 2.2-10.2 and a thickness of 0.05*λ_{g}, wherein λ_{g}=λ₀/εᵣ\hat{ }0.5, and λ₀ is a wavelength of free space.

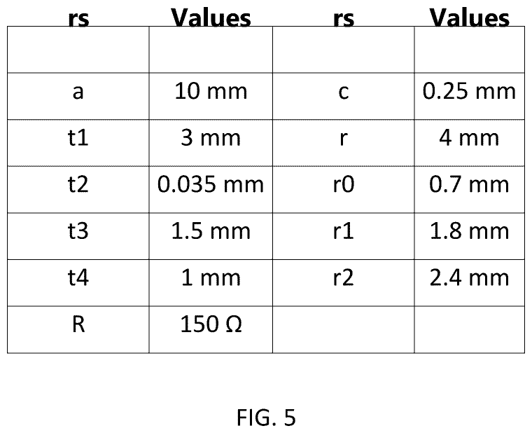

As shown in FIG. 5, the given table depicts the parameters values of MMRA unit. The metallic ground 9, dielectric substrate 10 and meta-dome 13 are squares with length a=10 mm. The centrally symmetric circular metal patch 1 is a circle with radius r0=0.7 mm, the hollow circular ring 4 has an inner radius r1=1.8 mm and an outer radius r2=2.4 mm, meta-surface patch is a circle with radius r=4 mm and strips on the meta-surface patch 8 have a width c=0.25 mm. The metallic ground 9 and meta-surface patch 11 both have a thickness t2=0.035 mm, dielectric substrate 10 has thickness t1=3 mm, air gap 12 has a thickness t3=1.5 mm and meta-dome 13 has thickness t4=1 mm. Finally, the resistors 7 have resistance R=150 Ω.

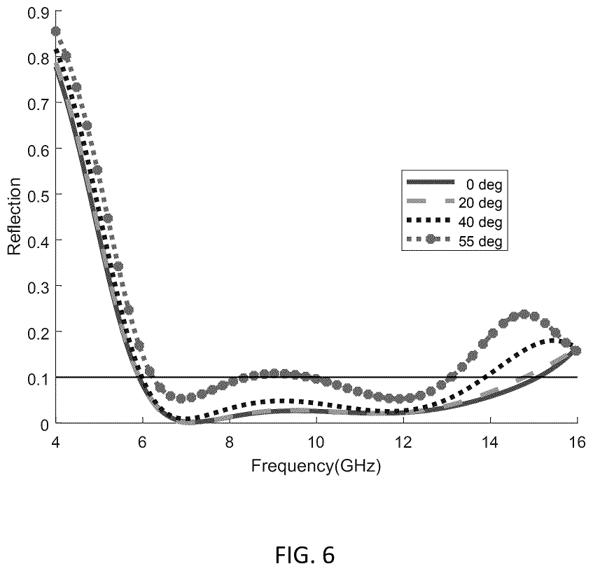

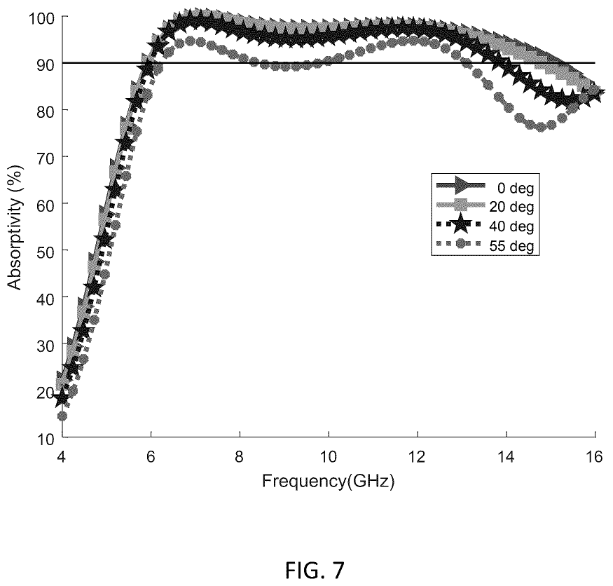

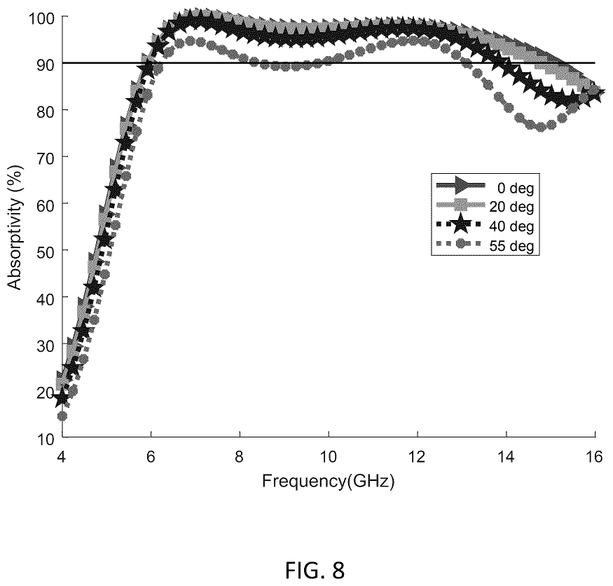

As shown in FIG. 6, the reflection is plotted on different angles (0°, 20°, 40° and 55°) and it has minimum value at frequencies ranging from 6 GHz to 18 GHz. Hence, the region having frequencies 6-18 GHz has maximum absorption (more than 90%) as depicted in FIG. 7 and FIG. 8, which also shows TE polarization and TM polarization respectively. These results proved that the present invention is angle insensitive as well as polarization insensitive.

As shown in FIG. 7, upon numerical computation, it can be seen that the absorptivity in the proposed frequency band (6-18 GHZ) is 90% or above, thus implementing the broadband MMRA.

What is claimed is:

1. A metamaterial-based radar absorber (MMRA), comprising:
a plurality of symmetrical MMRA units arranged in a two-dimensional periodic manner, wherein an MMRA unit of the plurality of symmetrical MMRA units comprises:
an upper meta-surface;
a dielectric substrate;
a metallic ground;
a dielectric Meta-dome; and
a group of resistors, wherein the upper meta-surface patch comprises:
a central circular meta-surface patch;
an outer circular meta-surface patch;
a hollow spherical ring; and
spaces between outer circular meta-surface patch, wherein:
at least a portion of the upper meta-surface patch is designed on the dielectric substrate and a bottom surface of the dielectric substrate is provided with the metallic ground;
the meta-surface patches below spherical ring is connected to each other through group of resistors; the meta-surface patches above spherical ring is connected to each other through resistors group; and meta-surface patches above the spherical ring are connected to meta-surface patches below spherical ring through resistors group; in this way all the meta-surface patches are connected to each other.

2. The MMRA unit according to claim 1, wherein the resistor group comprises:
A 1^{st} group of 12 resistors connected to the patches above spherical ring;
A 2^{nd} group of resistors connected between meta-surface patches above and below the spherical ring; and
A 3^{rd} group of resistors connected between meta-surface patches below the spherical ring.

3. The MMRA unit according to claim 1, wherein the perimeter of the meta-surface is λₒₚ/2, wherein λₒₚ=λ₀/(εᵣ+1)^{0.5}, and λ₀ is a wavelength of a free space.

4. The MMRA unit according to claim 1, wherein the dielectric substrate has a dielectric constant εᵣ of 2.2-10.2 and a thickness of 0.05*λ_{g}, wherein λ_{g}=λ₀/εᵣ\hat{ }0.5, and λ₀ is a wavelength of free space.

5. The MMRA unit according to claim 1, wherein an ultrawide-band radar absorber (UWBRA) is constructed on the basis of Metamaterials, wherein a resistance of resistors on the MMRA unit is controlled so that the impedance of the meta-surface matched with free space impedance and resonance occurred.

6. A circuit, comprising:
A plurality of centrally symmetrical metamaterial-based radar absorber (MMRA) units arranged in a two-dimensional periodic manner, wherein an MMRA unit of the plurality of MMRA units comprises:
An upper meta-surface patch;
A dielectric substrate;
A metal ground;
A meta-dome; and
A resistors group; wherein the upper meta-surface patch comprises:
A central circular meta-surface patch;
A group of cutting strips; and
An outer ring.

7. The circuit of claim 6, further comprising:
a group of meta-surface patches above and below the outer ring; wherein these meta-surface patches are connected to each other through group of resistors.

8. The MMRA according to claim 6, wherein meta-dome is constructed of dielectric substrate.
